(19) United States
(12) Patent Application Publication
(10) Pub. No.: US 2015/0106180 A1
(43) Pub. Date: Apr. 16, 2015

(54) CONTENT DOWNLOADS AND RIGHTS MANAGEMENT USING ADAPTIVE PRICING WITH COSTS OFFSET BY VIEWING ADVERTISEMENTS

(71) Applicant: Apple Inc., Cupertino, CA (US)

(72) Inventors: Mehul K. Sanghavi, Sunnyvale, CA (US); Michael Froimowitz Greenzeiger, Sunnyvale, CA (US); Ravindra Phulari, San Jose, CA (US)

(73) Assignee: Apple Inc., Cupertino, CA (US)

(21) Appl. No.: 14/055,722

(22) Filed: Oct. 16, 2013

(51) Int. Cl. G06Q 30/02

(52) U.S. Cl. CPC G06Q 30/0222; G06Q 30/0257
USPC 705/14.23

(57) ABSTRACT

The subject disclosure relates to a method for providing a downloadable content item including steps for providing a variety of offset-offers for a content item, wherein each of the offset-offers is associated with a different advertising amount and cost reduction amount and receiving a user request to download the content item, the user request specifying the user's selection of an offer from among the variety offset-offers, wherein the first offer corresponds with a first advertising amount and a first cost reduction amount. In certain aspects, the method can also include steps for preparing the first content item for download by the user. In some implementations, a content management system and computer readable media are also provided.

### BACKGROUND

1. Technical Field

The subject technology relates to a method of providing content downloads, and particularly to providing adaptive pricing options and management of embedded advertising content.

2. Introduction

An increasing amount of multimedia content is provided for sale to users via the Internet. Some conventional methods of selling content involve the offer of content in return for a fixed purchase price without the inclusion of advertisement. Once the purchase transaction is complete, the downloaded content can be repeatedly played to the user without the interruption of advertisement or need for further payment. In other conventional methods, content is provided in exchange for the user's agreement to watch or consume a certain amount of advertising. Advertising can be provided in advance, for example, before playback to the content is allowed. Alternatively, interstitial advertising can be used wherein advertising is embedded at different points in the content and provided at corresponding moments during playback.

User preferences for cost and advertising consumption can vary widely between different users and also for users as between different content items. For example, some users are particularly cost averse, but may not mind watching or consuming some advertising in exchange for a content item they would like to view. Alternatively, some users strongly dislike most forms of advertisement and would rather pay for the content they wish to consume rather than be subjected to advertising. As such, a need exists to personalize the sale of content that more accurately reflects a user's individual preferences for cost and advertisement consumption.

### SUMMARY

In certain aspects, the disclosed subject matter relates to a computer-implemented method for providing a downloadable content item. The method includes steps for providing a plurality of offset-offers for a first content item, wherein each of the offset-offers is associated with a different advertising amount and cost reduction amount, and receiving a user request to download the first content item, the user request specifying the user's selection of a first offer from among the plurality of offset-offers, wherein the first offer corresponds with a first advertising amount and a first cost reduction amount. In certain aspects, the method further includes steps for preparing the first content item for download by the user.

In another aspect, the disclosed subject matter relates to a system including one or more processors and a computer-readable medium comprising instructions stored therein, which when executed by the processors, cause the processors to perform operations including: providing a plurality of offset-offers for a first content item, wherein each of the offset-offers is associated with a different advertising amount and cost reduction amount, and receiving a user request to download the first content item, the user request specifying the user's selection of a first offer, from among the plurality of offset-offers, wherein the first offer corresponds with a first advertising amount and a first cost reduction amount. In certain aspects, the processors are further configured to perform operations including preparing the first content item for download by the user.

In another aspect, the disclosed subject matter relates to a computer-readable medium comprising instructions stored therein, which when executed by a processor, cause the processor to perform operations including: providing a plurality of offset-offers for a first content item, wherein each of the offset-offers is associated with a different advertising amount and cost reduction amount, and receiving a user request to download the first content item, the user request specifying the user's selection of a first offer, from among the plurality of offset-offers, wherein the first offer corresponds with a first advertising amount and a first cost reduction amount. In certain aspects the operations can further include steps for preparing the first content item for download by the user.

In another aspect, the disclosed subject matter relates to a computer-implemented method for managing user rights, including receiving a content item, the content item comprising a first cue point and a second cue point, the first cue point and second cue point respectively identifying a first advertisement and a second advertisement inserted at different locations in the content item, and tracking playback of the content item to determine an amount of advertising provided to a user. In certain aspects, the method can further include steps for removing the first advertisement from the content item in response to a determination that the amount of advertising provided to the user has exceeded a predetermined threshold.

In yet another aspect, the subject technology relates to a system for managing digital content, the system including one or more processors and a computer-readable medium including instructions stored therein, which when executed by the processors, cause the processors to perform operations including receiving a content item, the content item including a first cue point and a second cue point, the first cue point and second cue point respectively identifying a first advertisement and a second advertisement inserted at different locations in the content item. In certain aspects the processors can be further configured to perform operations including tracking playback of the content item to determine an amount of advertising provided to a user, and removing the first advertisement from the content item in response to a determination that the amount of advertising provided to the user has exceeded a predetermined threshold.

It is understood that other configurations of the subject technology will become readily apparent to those skilled in the art from the following detailed description, wherein various configurations of the subject technology are shown and described by way of illustration. The subject technology is capable of other and different configurations and its several details are capable of modification in various respects without departing from the scope of the subject technology. Accordingly, the detailed description and drawings are to be regarded as illustrative and not restrictive in nature.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates steps of an example method for providing a downloadable content item to a user, according to some aspects of the subject disclosure.

FIG. 2 illustrates steps of an example method for managing user rights to a content item, according to some aspects of the disclosure.

FIG. 3 illustrates an example of a network system that can be used to implement aspects of the subject technology.

FIG. 4 illustrates an example of an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

User preferences for advertising consumption and cost can vary widely, not only between different users, but also for a single user when purchasing different content items. For example, an otherwise advertising tolerant user may be averse to advertising played in conjunction with his/her favorite movie. As a consequence, the user may prefer to pay the full cost of the content (e.g., to download the movie), rather than consume advertising content in conjunction with its playback. Because of the wide variety of user preferences, there exists a need to provide customizable options for user content downloads.

The subject technology addresses the foregoing problem by providing ways in which a user can choose between multiple cost/advertising tradeoffs in exchange for a content item. For example, when deciding whether to purchase a content item, a user is presented with multiple options (e.g., “offset-offers”), each of which provide the user with a different combination of cost (e.g., a “cost amount”) and advertising (e.g., an “advertising amount”) that must be paid/consumed in return for access to the content item.

In some aspects, the cost amount and advertising amount are inversely related such that a greater cost paid for the content item corresponds with a smaller amount of advertising (e.g., a smaller advertising amount) that is included with the content item download. By way of example, an offset-offer with a full retail price may include no advertising. In contrast, an offset-offer for which the price is minimal (e.g., zero), can correspond with a maximum amount of advertising.

After a user has selected an offset-offer, the content item is prepared for download. As will be explained in further detail below, preparation of the content item can include the insertion of advertising directly into the content item. Alternatively, advertising can be later inserted into the content item at various cue points included throughout the content item.

The subject technology also provides methods and systems managing user content rights which can include tracking playback of a content item to determine how much advertising has been consumed by the user. After it is determined that the user's advertising consumption has reached a predetermined threshold, at least a portion of the advertising can be removed from the content item. For example, an advertising amount accepted by the user can specify a number of times (or an amount) of advertising that is provided to the user before the advertising is removed.

Once it is determined that the requisite amount of advertising has been provided to the user, some or all of the advertising content is removed from the content item. By way of example, suppose a user purchases a movie at a reduced cost corresponding with an amount of interstitial advertising that is included with the movie. After watching the advertising a certain number of times (as determined based on the advertising amount/cost reduction), the advertising is removed from the move by the content management system. Once advertising is removed, the content item remains free of advertising and can be played without further interruption to the user.

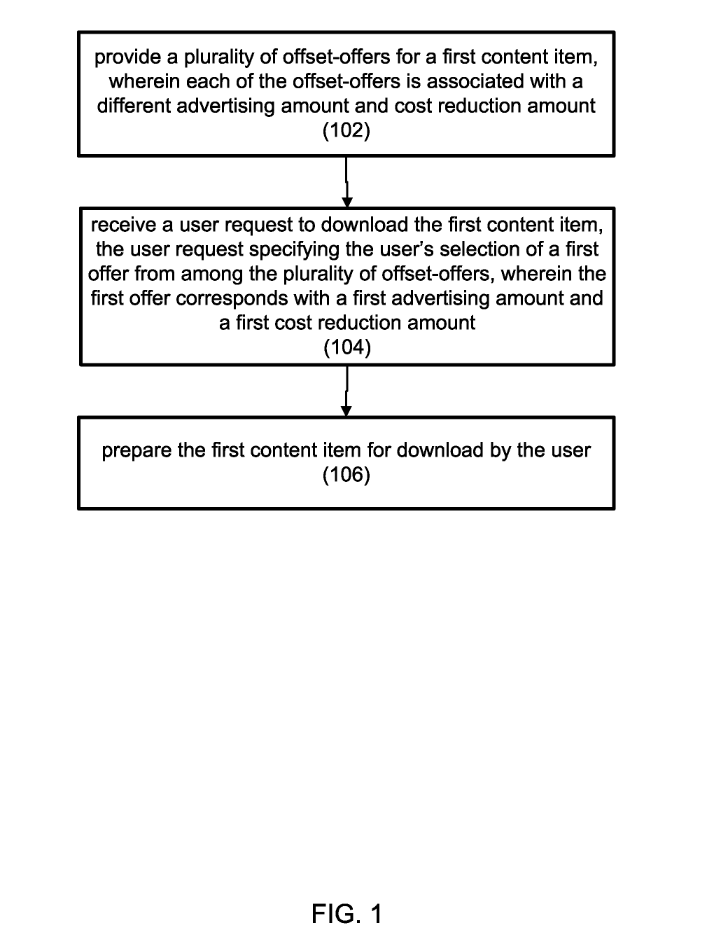

FIG. 1 illustrates steps of an example method 100 for providing a downloadable content item, according to some aspects of the disclosure. Method 100 begins with step 102 in which offset-offers for a content item (e.g., a first content item) are provided to a user. As discussed above, the offset-offers each correspond with an advertising amount (e.g., an amount of advertising to be included with the content item), as well as a cost amount that is offset by the amount of advertising to be included in the download. Each of the offset-offers can include a different advertising and cost combination. For example, an offset-offer with a relatively large advertising amount can also include a relatively low cost amount. Conversely, an offset-offer with a small advertising amount may include a larger relative cost amount.

In some implementations, different types of advertising content will have different values. That is, the cost amount for a content item that is offered in return for consumption of a first advertisement can be different from the cost amount for the same content item offered in return for consumption of a second (different) advertisement.

Additionally, offset-offers can be provided in various ways depending on implementation. For example, offset-offers can be presented to the user on a web page where the content item is sold and/or provided for download. Alternatively, offset-offers can be presented in a display window of client software, such as a display window of a content management system configured for the purchase and download of multimedia content, as will be discussed in further detail below.

It is understood that offset-offers can be presented in various manners, depending on implementation. For example, offset-offers may be presented as list of user selectable options. Alternatively, offset-offers may be displayed in the form of a moving scale that is adjustable between a maximum advertising amount (corresponding with a minimal cost), or a maximum cost amount (corresponding with a minimal advertising amount).

In step 104, a user request to download the first content item is received. In some implementations, the user request specifies the user's selection of a particular offer (e.g., a first offset-offer) from among multiple available offset-offers. The selected offset-offer corresponds with an advertising amount and cost amount that the user most closely matching the user's cost and advertising preferences, in exchange for the associated content item.

As discussed above, preferences for advertising and cost can vary widely between users. Similarly, a user's preferences for advertising and cost can vary widely depending on the content item that the user wishes to download. By presenting the user with multiple options (e.g., multiple offset-offers), the user can choose a relative cost and amount of advertising consumption that best fits his/her preferences for each purchased content item.

In step 106, the content item (e.g., the first content item) is prepared for download by the user. Preparation of the content item can involve a variety of editing and processing tasks. In some implementations, an amount of advertising that is commensurate with the advertising amount indicated by the selected offset-offer (e.g., the first offset-offer of step 102), is included with the content item. For example, interstitial advertising can be inserted at one or more points within the content item that is provided to the user. Locations in the content item where advertising is inserted can be flagged using cue points, for example, to indicate to a media player or content management system that those locations include advertising content. As will be discussed in further detail below, cue points can also be used to help track an amount of advertising that has been watched, or consumed, by the user.

Preparation of the content item for download can involve the insertion of cue points at one or more locations in the content item to indicate where advertising is to be later added. For example, advertising content can be received by an online user device and inserted at locations in the content item where one or more cue points are included. In certain aspects, cue points can also be used to mark portions of content that are locked or inaccessible for playback by the user until certain amounts of advertising have been consumed. For example, playback of a content item can be restricted up to a particular cue point, after which, access to remaining content requires further advertising consumption by the user.

Additionally, cue points can also be used to update or modify advertising that has been inserted into an already downloaded content item. For example, a user may download a content item that has been processed to include a bundle of advertising content. At a later time, it may be determined that the advertising included in the content item is outdated, or that different advertising is preferred. As such, cue points in the content item can be used to specify content item locations where new/updated advertising can be inserted. In this manner, current and relevant advertising content can be continuously included in a content item after the content item has already been downloaded and stored by the user.

User rights to a content item can be managed using a content management system on a user device, such as a smart phone, personal computer, and/or tablet device, etc. As discussed above, the content management system can perform various functions to manage user rights for one or more content items. For example, the content management system can be configured to track an amount of advertising that has been consumed with respect to a content item and/or facilitate the updating of a content item to remove advertising once a predetermined advertising consumption threshold has been reached.

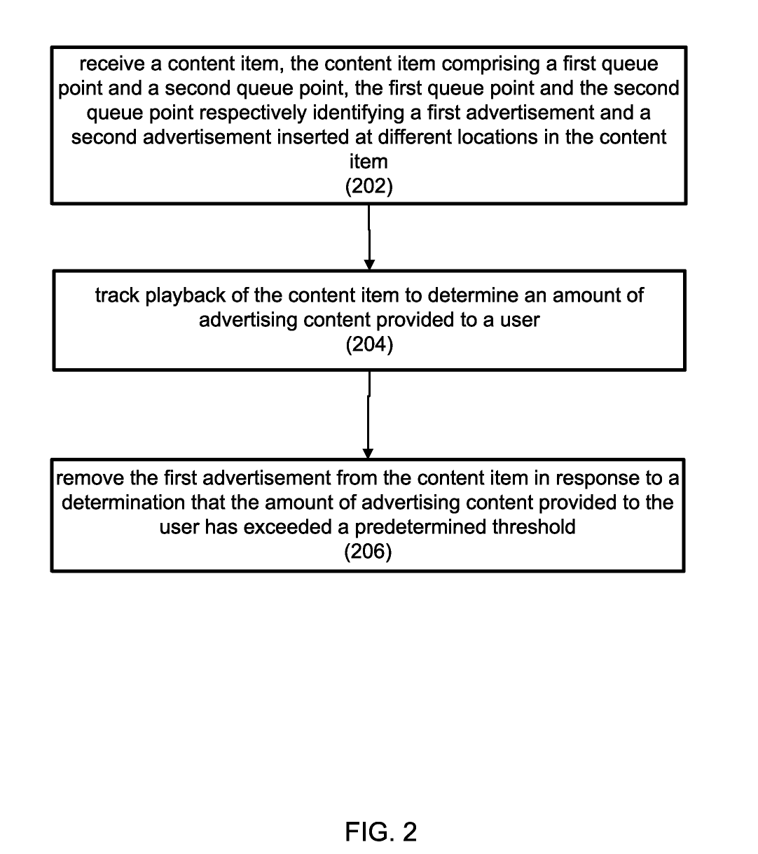

FIG. 2 illustrates steps of an example method 200 for managing user rights to a content item (e.g., using a content management system), according to some aspects of the disclosure. Method 200 begins with step 202 in which a content item is received (e.g., downloaded and/or accessed on a user device). The content item includes a first cue point and a second cue point respectively identifying a first advertisement and a second advertisement inserted in the content item.

It is understood that a fewer, or greater, number of cue points and/or advertisements can be included in the content item, without departing from the scope of the subject technology. Additionally, depending on implementation, the first advertisement and the second advertisement can represent different advertisements, or different portions of a common advertisement.

In step 204, playback of the content item is tracked to determine an amount of advertising content provided to the user. Advertising playback can be performed differently depending on implementation. For example, advertising playback can include the playback of only audio or sound information to the user. Alternatively, advertising playback can involve the display of video content.

Tracking of advertising playback is performed to measure an amount of advertising that provided to the user (i.e., consumed by the user). Tracking can be performed in different ways depending on implementation. For example, tracking can be performed by totaling a number of times that a cue point has been passed during playback of the content item. Further to the above example, if it is determined that the first cue point has been passed five times, it may be inferred that the advertising associated with the first cue point (i.e., the first advertisement) has been provided five times to the user.

Tracking can also be based on a total runtime of advertisement that is provided to the user. Suppose for example that the first advertisement has a total runtime of three minutes, and that the second advertisement has a runtime of five minutes. In this example, tracking may indicate that a user who views the first advertisement a total of five times has consumed the advertising equivalent of viewing the second advertisement three times.

In certain aspects, tracking of advertisement consumption can be performed at a user account level, for example, in relation to a user account associated with a media player and/or digital rights management system of the subject technology. For example, advertisement tracking can be performed for a user account that is shared by multiple users, each of whom may use different devices (e.g., smart phones, personal computers, and/or tablet computing devices) for playing multimedia content. In such instances, the advertisement consumption of each individual user (or user device) may be accounted for to determine a total advertising consumption with respect to the commonly associated user account. Thus, depending on implementation, tracking can be performed at the account level or at the individual/device level, to determine total advertising consumption.

Factors indicating a greater degree of user engagement with an advertisement may be accounted for when determining how much credit/weight is to be awarded for playback of the advertisement. For example, a first playback of an advertisement can be counted differently than that of a repeated playback of the same advertisement (i.e., advertisement recall), because subsequent viewings of an advertisement can indicate a higher degree of user engagement. Thus, playbacks of an advertisement may be credited at a higher value than that of a first impression.

In step 206, the first advertisement is removed from the content item in response to a determination that the amount of advertising provided to the user has exceeded predetermined threshold. The requisite threshold to be met before advertising is removed depends on the amount of advertising included with the content item upon purchase (e.g., an advertising amount agreed upon the user when the offset-offer was selected, as discussed above). Alternatively, the requisite threshold can be specified by metadata and/or cue points included with the content item that can specify locations in the content item where advertising can be inserted and provided to the user upon playback.

By way of example, suppose that when purchasing a movie, a user selects an offset-offer wherein five dollars is discounted from the original purchase price in exchange for twenty-minutes of advertising consumption. That is, once received by the user, the movie will include enough advertising to provide the user with twenty-minutes of advertising exposure. Upon playback of the movie, advertising can be provided at one or more times corresponding with cue points in the content item, and tracked to determine whether the predetermined threshold (e.g., twenty-minutes of advertising playback) has been reached. Once it is determined that twenty-minutes of advertising has been provided to the user, the advertising can be altogether removed from the content item. Subsequently, the user is provided unrestricted access and playback rights to the content item without further advertising interruptions.

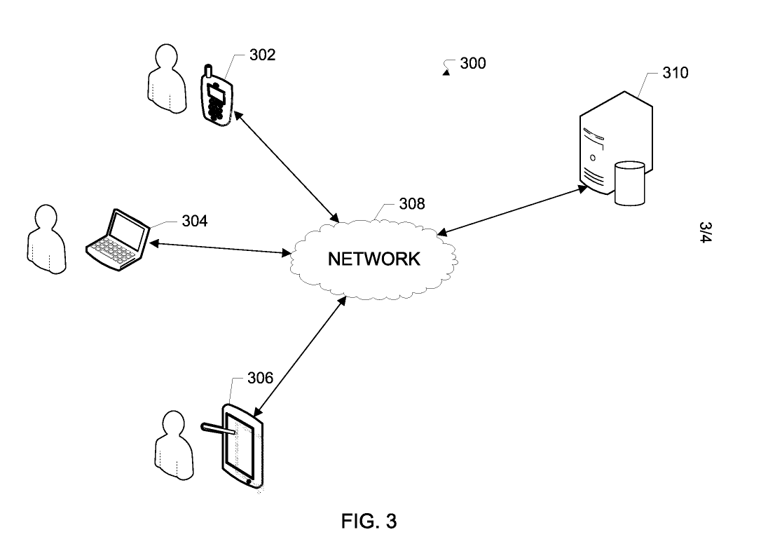

FIG. 3 conceptually illustrates an example of a network system 300 that can be used to implement aspects of the subject technology. Network system 300 includes user devices 302, 304, 306, server 310, and a network 308. As illustrated, user devices 302, 304 and 306 are communicatively connected to server 310 via network 308. It is understood that in addition to user devices 302, 304 and 306, any number of other processor-based user devices could be communicatively connected to the network 308. Similarly, additional servers could be coupled to network 308, each of which may be configured to perform all, any portion of the method steps of the subject technology. Additionally, network 308 can comprise multiple networks, such as a network of networks, e.g., the Internet.

One or more of the process steps of the subject technology may be carried out by one or more of user devices 302, 304, 306 and/or server 310. For example, server 310 can be configured to host a content database of downloadable content items. By way of example, server 310 can be used to provide offset-offers and to process one or more content items to include advertising that is commensurate with a user selected offset offer.

Similarly, of user devices 302, 304 and/or 306 can include hardware and/or software forming a content management system of the subject invention. As such, one or more processors of user devices 302, 304 and/or 306 can be configured to receive a content item, for example from server 310, and to track playback of the content item to determine an amount of advertising that has been provided to a user.

Once a predetermined amount or threshold of advertising content has been provided to the user, the content management system can remove advertising content from the content item. In certain aspects, the amount of advertising provided to the user is determined based on a number of times the first cue point has been reached during playback of the content item. In another aspect, tracking playback of the content item to determine an amount of advertising provided to the user can include determining a duration of advertising that has been provided to the user.

Many of the above-described features and applications may be implemented as software processes that are specified as a set of instructions recorded on a computer-readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, optical recording media, flash drives, RAM chips, hard drives and/or EPROMs, etc. It is understood that computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

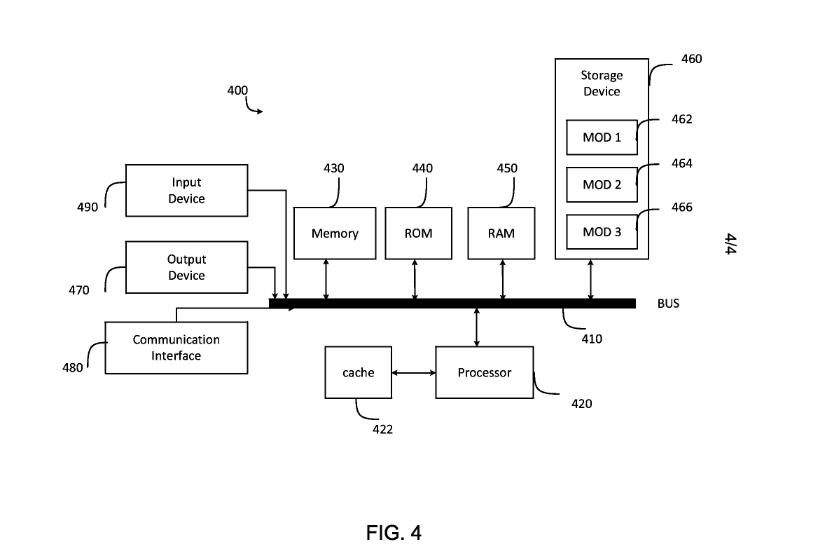

FIG. 4 illustrates an example of an electronic system with which some aspects of the subject technology can be implemented. As illustrated, system 400 includes a general-purpose computing device 400, including processing unit (CPU or processor) 420 and system bus 410 that couples various system components including system memory 430, a read only memory (ROM) 440 and random access memory (RAM) 450, to processor 420.

System 400 can include a cache 422 of high speed memory connected directly with, in close proximity to, or integrated as part of processor 420. System 400 copies data from memory 430 and/or storage device 460 to cache 422 for quick access by processor 420. In this way, cache 422 provides a performance boost that avoids processor 420 delays while waiting for data. These and other modules can control or be configured to control processor 420 to perform various actions. Other system memory 430 may be available for use as well. Memory 430 can include multiple different types of memory with different performance characteristics. It can be appreciated that the disclosure may operate on computing device 400 which includes more than one processor 420 or on a group or cluster of computing devices networked together to provide greater processing capability.

Processor 420 can include any general purpose processor and a hardware module or software module, such as module 1 462, module 2 464, and module 3 466 stored in storage device 460, configured to control processor 420 as well as a special-purpose processor where software instructions are incorporated into the actual processor design. Processor 420 may essentially be a completely self-contained computing system, containing multiple cores or processors, a bus, memory controller, cache, etc. A multi-core processor may be symmetric or asymmetric.

System bus 410 may be any of several types of bus structures including a memory bus or memory controller, a peripheral bus, and a local bus using any of a variety of bus architectures. A basic input/output (BIOS) stored in ROM 440 or the like, can provide basic routines that help to transfer information between elements within computing device 400, such as during start-up. Computing device 400 can further include storage devices 460 such as a hard disk drive, a magnetic disk drive, an optical disk drive, tape drive or the like. Storage device 460 can include software modules 462, 464, 466 for controlling the processor 420. Storage device 460 is connected to system bus 410 by a drive interface. The drives and the associated computer readable storage media provide nonvolatile storage of computer readable instructions, data structures, program modules and other data for computing device 400.

In one aspect, a hardware module that performs a particular function includes the software component stored in a non-transitory computer-readable medium in connection with the necessary hardware components, such as processor 420, bus 410 and so forth, to carry out the function. The basic components are known to those of skill in the art and appropriate variations are contemplated depending on the type of device, such as whether the device 400 is a handheld computing device, such as a smart phone, or larger computing device, such as a desktop computer, or a computer server.

By way of example, processor 420 can be configured to execute operations to provide a plurality of offset-offers for a first content item, wherein each of the offset-offers is associated with a different advertising amount and cost reduction amount, and receive a user request to download the first content item, the user request specifying the user's selection of a first offer from among the plurality of offset-offers, wherein the first offer corresponds with a first advertising amount and a first cost reduction amount. In certain aspects, processor 420 can be further configured to prepare the first content item for download by the user.

Preparation of the first content item can further include steps for inserting advertising into the first content item, wherein the duration of the inserted advertising is based on the first advertising amount specified by the user request. Furthermore, in certain aspects, the user request can indicate a tradeoff between a price that a user is willing to pay for the first content item and an amount of advertising that the user is willing to consume.

In another aspect, preparation of the first content item can also include steps for selecting advertising for insertion into the first content item based on the first advertising amount specified by the user request and processing the advertising and the first content item to insert different portions of the advertising at different intervals in the first content item.

In yet another aspect, preparing the first content item for download by the user comprises processing the first content item to insert a plurality of cue points at different intervals in the first content item based on the first advertising amount specified by the user request, wherein the plurality of cue points indicate locations in the first content item where advertising can be inserted.

Although the exemplary embodiment described herein employs storage device 460, it should be appreciated by those skilled in the art that other types of computer readable media which can store data that are accessible by a computer, such as magnetic cassettes, flash memory cards, digital versatile disks, cartridges, random access memories (RAMs) 450, read only memory (ROM) 440, a cable or wireless signal containing a bit stream and the like, may also be used in the exemplary operating environment. Non-transitory computer-readable storage media expressly exclude media such as energy, carrier signals, electromagnetic waves, and transitory signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 420. The functions these blocks represent may be provided through the use of either shared or dedicated hardware, including, but not limited to, hardware capable of executing software and hardware, such as a processor 420, that is purpose-built to operate as an equivalent to software executing on a general purpose processor. For example, the functions of one or more processors may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 440 for storing software performing the operations discussed below, and random access memory (RAM) 450 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 400 can practice all or part of the recited methods, can be a part of the recited systems, and/or can operate according to instructions in the recited non-transitory computer-readable storage media. Such logical operations can be implemented as modules configured to control the processor 420 to perform particular functions according to the programming of the module.

For example, FIG. 4 illustrates three modules Mod1 462, Mod2 464 and Mod3 466 that are modules configured to control the processor 420. These modules may be stored on the storage device 460 and loaded into RAM 450 or memory 430 at runtime or may be stored as would be known in the art in other computer-readable memory locations.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer-implemented method for providing a downloadable content item, the method comprising:
providing a plurality of offset-offers for a first content item, wherein each of the offset-offers is associated with a different advertising amount and cost reduction amount;
receiving a user request to download the first content item, the user request specifying the user's selection of a first offer from among the plurality of offset-offers, wherein the first offer corresponds with a first advertising amount and a first cost reduction amount; and
preparing the first content item for download by the user.

2. The computer-implemented method of claim 1, wherein preparing the first content item for download further comprises:
inserting advertising into the first content item, and
wherein a duration of the inserted advertising is based on the first advertising amount specified by the user request.

3. The computer-implemented method of claim 1, wherein the user request indicates a tradeoff between a price that a user is willing to pay for the first content item and an amount of advertising that the user is willing to consume.

4. The computer-implemented method of claim 1, wherein preparing the first content item for download further comprises:
selecting advertising for insertion into the first content item based on the first advertising amount specified by the user request; and
processing the first content item to insert portions of the advertising at different intervals in the first content item.

5. The computer-implemented method of claim 1, wherein preparing the first content item for download by the user further comprises:
processing the first content item to insert a plurality of cue points at different intervals in the first content item based on the first advertising amount specified by the user request, wherein the plurality of cue points indicate locations in the first content item where advertising can be inserted.

6. A system comprising:
one or more processors; and
a computer-readable medium comprising instructions stored therein, which when executed by the processors, cause the processors to perform operations comprising:
providing a plurality of offset-offers for a first content item, wherein each of the offset-offers is associated with a different advertising amount and cost reduction amount;
receiving a user request to download the first content item, the user request specifying the user's selection of a first offer, from among the plurality of offset-offers, wherein the first offer corresponds with a first advertising amount and a first cost reduction amount; and
preparing the first content item for download by the user.

7. The system of claim 6, wherein preparing the first content item further comprises:
inserting advertising into the first content item, and
a duration of the inserted advertising is based on the first advertising amount specified by the user request.

8. The system of claim 6, wherein the user request indicates a tradeoff between a price that a user is willing to pay for the first content item and an amount of advertising that the user is willing to consume.

9. The system of claim 6, wherein preparing the first content item further comprises:
selecting advertising for insertion into the first content item based on the first advertising amount specified by the user request; and
processing the advertising and the first content item to insert different portions of the advertising at different intervals in the first content item.

10. The system of claim 6, wherein preparing the first content item further comprises:
processing the first content item to insert a plurality of cue points at different intervals in the first content item based on the first advertising amount specified by the user request, wherein the plurality of cue points indicate locations in the first content item where advertising can be inserted.

11. A computer-readable storage medium comprising instructions stored therein, which when executed by one or more processors, cause the processors to perform operations comprising:
providing a plurality of offset-offers for a first content item, wherein each of the offset-offers is associated with a different advertising amount and cost reduction amount;
receiving a user request to download the first content item, the user request specifying the user's selection of a first offer, from among the plurality of offset-offers, wherein the first offer corresponds with a first advertising amount and a first cost reduction amount; and
preparing the first content item for download by the user.

12. The computer-readable storage medium of claim 11, wherein preparing the first content item for download by the user further comprises:
inserting advertising into the first content item, and
wherein a duration of the inserted advertising is based on the first advertising amount specified by the user request.

13. The computer-readable storage medium of claim 11, wherein preparing the first content item for download by the user further comprises:
selecting advertising for insertion into the first content item based on the first advertising amount specified by the user request; and
processing the advertising and the first content item to insert different portions of the advertising at different intervals in the first content item.

14. The computer-readable storage medium of claim 11, wherein preparing the first content item for download by the user further comprises:
processing the first content item to insert a plurality of cue points at different intervals in the first content item based on the first advertising amount specified by the user request, wherein the plurality of cue points indicate locations in the first content item where advertising can be inserted.

15. A computer-implemented method for managing user rights, comprising:
receiving a content item, the content item comprising a first cue point and a second cue point, the first cue point and second cue point respectively identifying a first advertisement and a second advertisement inserted at different locations in the content item;
tracking playback of the content item to determine an amount of advertising provided to a user; and
removing the first advertisement from the content item in response to a determination that the amount of advertising provided to the user has exceeded a predetermined threshold.

16. The computer-implemented method of claim 15, wherein the amount of advertising provided to the user is determined based on a number of times the first cue point has been reached during playback of the content item.

17. The computer-implemented method of claim 15, wherein tracking playback of the content item to determine an amount of advertising provided to the user comprises:
determining a duration of the advertising that has been provided to the user.

18. The computer-implemented method of claim 15, further comprising:
identifying new advertising to be inserted into the content item; and
updating at least a portion of the first advertisement by inserting the new advertising into the content item at the first cue point.

19. The computer-implemented method of claim 15, wherein tracking playback of the content item further comprises:
determining if the second advertisement has been provided to the user; and
restricting playback of at least a portion of the content item after the second cue point in response to a determination that the second advertisement has not been provided to the user.

20. A system for managing digital content, comprising:
one or more processors; and
a computer-readable medium comprising instructions stored therein, which when executed by the processors, cause the processors to perform operations comprising:
receiving a content item, the content item comprising a first cue point and a second cue point, the first cue point and second cue point respectively identifying a first advertisement and a second advertisement inserted at different locations in the content item;
tracking playback of the content item to determine an amount of advertising provided to a user; and
removing the first advertisement from the content item in response to a determination that the amount of advertising provided to the user has exceeded a predetermined threshold.
